(19) United States
(12) Patent Application Publication
(10) Pub. No.: US 2012/0135174 A1
(43) Pub. Date: May 31, 2012

(54) RELEASE AGENT, RELEASE MATERIAL, AND PRESSURE-SENSITIVE ADHESIVE TAPE

(75) Inventors: Tsuyoshi Hiramatsu, Ibaraki-shi (JP); Tomoko Hatanaka, Ibaraki-shi (JP); Toru Iseki, Ibaraki-shi (JP)

(73) Assignee: NITTO DENKO CORPORATION, Ibaraki-shi, Osaka (JP)

(21) Appl. No.: 13/389,361

(22) PCT Filed: Aug. 6, 2010
(86) PCT No.: PCT/JP2010/063344

§ 371 Date: Feb. 7, 2012

(30) Foreign Application Priority Data
Aug. 7, 2009 (JP) 2009-184531
Jul. 16, 2010 (JP) 2010-162230

(51) Int. Cl. C09J 7/02; C09D 175/14; B32B 27/32

(52) U.S. Cl. 428/41.3; 524/507

(57) ABSTRACT

Provided is a release agent capable of maintaining the inherent detachability of polyolefin and showing good adhesion to the substrate and a release material using the release agent, and an adhesive tape having such release material. A release agent containing at least a polyolefin, an aromatic isocyanate having three or more isocyanate groups in one molecule, and a polyolefin polyol having a number-average molecular weight of 1500 to 5000.

### TECHNICAL FIELD

The present invention relates to a release agent containing polyolefin, which is superior in adhesion to a substrate, and a release material containing the agent, and also relates to an adhesive tape having the release material.

### BACKGROUND ART

A release material has a release agent layer on at least one surface of a substrate such as paper, plastic film, or plastic-laminated paper, and is used to protect adhesive surfaces of adhesive tapes, adhesive sheets, labels and the like, and is used in manufacturing processes for ceramic greensheets and the like.

The kind of release agent includes silicone-based release agent, long-chain alkyl-based release agent, polyolefin-based release agent, and fluorinated release agent, and they are used in distinct ways according to the use. Of these, silicone-based release agents are problematic in that they may cause corrosion and malfunctions due to the generation of siloxane gas when used for applications requiring precision such as those related to electronic components, and therefore, non-silicone-based release agents such as polyolefin-based release agents are used.

Release materials using a polyolefin-based release agent include those described in Patent Documents 1 to 3. Of these, Patent Documents 1 and 2 propose release materials prepared by applying a polyolefin dissolved in an organic solvent to a substrate, and drying the same. However, the release materials are problematic in the adhesion to a substrate, though a peel force corresponding to the inherent detachability of polyolefin is obtained, since the obtained release material shows easy exfoliation of the release agent layer when rubbed with fingertips and the like.

Patent Document 3 proposes a release agent prepared by crosslinking a modified polyolefin having a functional group and an isocyanate-based crosslinking agent, and a release agent concurrently using an unmodified polyolefin having no functional group, and describes that a release agent with improved levels of solvent resistance, heat resistance and adhesion to a substrate can be obtained. As stated in paragraph [0010], however, the release agent described in Patent Document 3 uses a polyolefin having a functional group as the aforementioned polyolefin, and a crosslinking agent that is compatible and crosslinkable with the polyolefin as the aforementioned isocyanate-based crosslinking agent. Therefore, when the release agent is stored while in a state bonded to an adhesive tape, these ingredients can act on the ingredients in the adhesive and tend to increase the peel force under some storage conditions, and the peel force is likely to increase particularly when the release agent is stored at temperatures of 50 to 70° C. or more.

### DOCUMENT LIST

### Patent Documents

patent document 1: JP-A-S55-152775
patent document 2: JP-A-H06-99551
patent document 3: JP-A-2004-91776

### SUMMARY OF THE INVENTION

### Problems to be Solved by the Invention

In view of the above-described circumstances, it is a problem to be solved by the present invention to obtain a release agent that exhibits excellent adhesion to a substrate and maintains the inherent detachability of polyolefin, a release material using the agent, and an adhesive tape having the release material.

### Means of Solving the Problems

The present inventors extensively investigated to solve the above-described problems, as a result found that when using a composition comprising at least a polyolefin, an aromatic isocyanate having three or more isocyanate groups in one molecule, and a polyolefin polyol having a number-average molecular weight of 1500 to 5000, as a release agent, and applying this to a substrate, the composition separates into a layer with the polyolefin as a main component and a layer with the aromatic isocyanate as a main component, and a release agent layer can be formed in a state wherein the layer with the aromatic isocyanate as a main component is localized between the layer with the polyolefin as a main component and the substrate, conducted further investigations based on this finding, and have developed the present invention.

Accordingly, the present invention is as follows:
(1) A release agent comprising at least a polyolefin, an aromatic isocyanate having three or more isocyanate groups in one molecule, and a polyolefin polyol having a number-average molecular weight of 1500 to 5000.
(2) The release agent of the above-mentioned (1), wherein the aromatic isocyanate is an adduct of an aromatic diisocyanate with a polyhydric alcohol.
(3) The release agent of the above-mentioned (1) or (2), wherein the content of the aromatic isocyanate is 0.5 to 20 parts by weight relative to 100 parts by weight of the polyolefin.
(4) A release material having a release agent layer comprising the release agent of any one of the above-mentioned (1) to (3) on at least one surface of a substrate.
(5) An adhesive tape having the release material of the above-mentioned (4) on at least one surface of an adhesive layer.
(6) An adhesive tape having an adhesive layer on one surface of a substrate, and having a back coating layer comprising the release agent of any one of the above-mentioned (1) to (3) on the outermost surface of the other surface.

### Effect of the Invention

According to the release agent of the present invention, a release material can be realized that exhibits excellent adhesion to a substrate and maintains the inherent detachability of polyolefin.

By forming a back coating layer consisting of the release agent of the present invention on the surface opposite to a surface having an adhesive layer of a substrate, an adhesive tape that maintains excellent self-back-detachability can be obtained.

### BRIEF SPECIFICATION OF THE DRAWINGS

FIG. 1 is a transmission electron microscopy (TEM) photomicrograph of a cross-section of the release agent layer in the release material prepared in Example 1.

FIG. 2 is a drawing showing the results of an X-ray photoelectron spectroscopy (XPS) analysis in the depth direction of the release agent layer in the release material generated in Example 1. In the drawing, the arrow a indicates carbon coming from the release agent and the substrate, the arrow b indicates oxygen coming from the release agent and the substrate (polyester film), and the arrow c indicates nitrogen coming from the isocyanate in the release agent.

### MODES FOR EMBODYING THE INVENTION

### 1. Release Agent

The present invention provides a release agent comprising at least a polyolefin, an aromatic isocyanate having three or more isocyanate groups in one molecule, and a polyolefin polyol having a number-average molecular weight of 1500 to 5000.

### [Polyolefin]

Although any polyolefin can be used in the present invention, as far as it can be applied to the substrate in solution in an organic solvent along with other materials, it is preferable in view of the solubility in organic solvents to use a low-density polyolefin.

Specifically, polyolefin having a density of 0.885 g/cm³ or less is preferable, and polyolefin having a density of 0.880 g/cm³ or less is more preferable. When the density exceeds 0.885 g/cm³, the solubility in organic solvents decreases so that application to the substrate tends to be difficult, and so that the detachability tends to decrease. The lower limit value is not particularly limited, but is preferably 0.830 g/cm³ or more.

Examples of such polyolefin having low density include α-olefin copolymer containing, as a monomer unit, at least two kinds selected from the group consisting of ethylene, propylene and α-olefin having a carbon number of 4-20. Of these, a copolymer containing ethylene as a principal monomer unit (that is, ethylene-based a-olefin copolymer) and/or a copolymer having propylene as a principal monomer unit (that is, propylene-based α-olefin copolymer) are/is preferable. Here, examples of the α-olefin having a carbon number of 4-20 include 1-butene, 1-pentene, 3-methyl-1-butene, 1-hexene, 4-methyl-1-pentene, 3-methyl-1-pentene, 1-heptene, 1-octene, 1-decene, 1-dodecene and the like. In addition, the α-olefin copolymer may be any of a random copolymer, a block copolymer and a graft copolymer.

Ethylene-based α-olefin copolymer (density: 0.857 to 0.885 g/cm³) preferably comprises 50 to 95 mol %, more preferably 70 to 95 mol %, of an ethylene unit; and one or more kinds selected from 1-butene, propylene, 1-hexene, and 1-octene are preferably used as a monomer unit other than ethylene. Particularly preferable copolymer includes ethylene-1-butene copolymer, ethylene-propylene copolymer and the like. Such ethylene-1-butene copolymer may contain a monomer unit derived from an α-olefin other than ethylene and 1-butene in an amount of 10 mol % or less; and ethylene-propylene copolymer may contain a monomer unit derived from an α-olefin other than ethylene and propylene in an amount of 10 mol % or less. Such a copolymer can be obtained by, for example, copolymerizing ethylene and an α-olefin using a catalyst consisting of a transition metal catalytic component (e.g., vanadium compounds, zirconium compounds) and an organic aluminum compound catalytic component so that the ethylene unit content in the copolymer will be as described above.

A propylene-based α-olefin copolymer (density: 0.858 to 0.885 g/cm³) preferably comprises more than 50 mol % and not more than 95 mol %, more preferably 70 to 95 mol %; of a propylene content, and one or more kinds selected from among ethylene, 1-butene, 1-hexene, and 1-octene as a monomer unit other than propylene. Particularly preferable copolymer is propylene-ethylene random copolymer (propylene-based elastomer). The propylene-ethylene random copolymer (propylene-based elastomer) may contain propylene and a monomer unit derived from an α-olefin other than ethylene in an amount of 10 mol % or less. A propylene-based α-olefin copolymer in the present invention can be produced by, for example, using a metallocene-based catalyst, as described in JP-A-2000-191862.

In the present invention, the α-olefin copolymer may be a commercially available product. As the ethylene-based α-olefin copolymer, TAFMER P series, TAFMER A series (all manufactured by Mitsui Chemicals, Inc.), ENGAGE (manufactured by Dow Chemical Company) and the like are preferably used. As the propylene-series α-olefin copolymer, TAFMER XM series (manufactured by Mitsui Chemicals, Inc.) and the like are preferably used.

As polyolefin in the present invention, polymethylpentene can also be used. Polymethylpentene may be a homopolymer of 4-methyl-1-pentene, or a copolymer of 4-methyl-1-pentene and ethylene or α-olefin other than 4-methyl-1-pentene. It is a crystalline polymer preferably containing 50-95 mol %, more preferably 70-95 mol %, of 4-methyl-1-pentene as a principal monomer unit, which has an extremely low density of 0.83-0.86 g/cm³. As α-olefin other than 4-methyl-1-pentene, α-olefin having a carbon number of 3-20 such as propylene, 1-butene, 1-hexene, 1-octene, 1-decene, 1-tetradecene, 1-octadecene and the like can be used. Of these, 1-decene, 1-tetradecene and 1-octadecene are preferable, since they exhibit good copolymerizability with 4-methyl-1-pentene. As a commercially available product of poly 4-methylpentene-1, TPX-S (manufactured by Mitsui Chemicals, Inc.) can be mentioned.

In addition, polyolefin in the present invention is a concept including a polymer containing diolefin such as isoprene, butadiene and the like as a monomer unit, and diene rubbers such as polyisoprene, polybutadiene and the like can also be used as long as they can be dissolved in an organic solvent. Examples of such diene rubber include polyisoprene (one having cis-1,4 bond in not less than 90%, density 0.90-0.92 g/cm³, Mooney viscosity 40-70ML(1+4) 100° C.), and commercially available products (IR-307, IR-310 (manufactured by Kraton Performance Polymers Inc.). As polybutadiene, those having cis-1,4 bond in not less than 90%, density 0.88-0.91 g/cm³, and Mooney viscosity 25-50ML(1+4) 100° C., and commercially available products such as Nipol BR1220, Nipol BR1220L (manufactured by ZEON CORPORATION), and BR01 (manufactured by JSR) can be mentioned.

Although it is preferable that the polyolefin in the present invention do not react with the aromatic isocyanates described below, the polyolefin may be modified with a functional group such as a hydroxyl group, amino group, carboxyl group, or isocyanate group, as far as the object of the present invention is not interfered with. However, the number of functional groups in one molecule is preferably 1 or less.

In the present invention, to adjust the peel force, one or more kinds of polyolefins can be used. Particularly when a polyolefin is used in combination with an acrylic adhesive, it is preferable to use an ethylene-based α-olefin copolymer and/or a propylene-based α-olefin copolymer because the peel force is unlikely to rise over time. When the release agent is used for a use application that requires a relatively large peel force, a propylene-based α-olefin copolymer and/or polymethylpentene is preferable.

In the present invention, when only one kind of polyolefin is used, it preferably has MFR (melt flow rate) at 230° C. of not more than 100 g/10 min, more preferably not more than 70 g/10 min, further preferably not more than 50 g/10 min, particularly preferably not more than 10 g/10 min, in view of the strength of the coated film when forming a release agent layer.

In addition, when two or more kinds of polyolefin are used, at least one kind thereof preferably has MFR at 230° C. of not more than 100 g/10 min. In addition, the proportion of polyolefin having MFR of not more than 100 g/10 min in a release agent is preferably not less than 10 wt %, more preferably not less than 50 wt %. As long as this condition is satisfied, a polyolefin having MFR at 230° C. of more than 100 g/10 min can be used as other polyolefin.

The content of polyolefin in the release agent is preferably 80 to 99% by weight, more preferably 90 to 98% by weight. When the content is less than 80% by weight, the detachability worsens and the peel force highly tends to increase; if the content exceeds 99% by weight, it is difficult to obtain sufficient coating strength because the amount of crosslinking ingredients is too small.

### [Aromatic Isocyanate]

The aromatic isocyanate in the present invention is used as a crosslinking ingredient. An aromatic isocyanate is preferable because better adhesion to a substrate is obtained than with an aliphatic isocyanate. From the viewpoint of the strength and heat resistance of the release agent layer, aromatic isocyanates having three or more isocyanate groups in one molecule are preferable. Such aromatic isocyanates having three or more isocyanate groups in one molecule include, for example, trimerized products (trimers) of aromatic diisocyanate compounds such as trilene diisocyanate, diphenylmethane diisocyanate, 1,5-naphthylene diisocyanate, tolidine diisocyanate, xylylene diisocyanate, and tetramethylxylylene diisocyanate, or terminal-isocyanate-containing compounds obtained by reacting an excess amount of such an aromatic diisocyanate compound with a polyhydric alcohol (an adduct of an aromatic diisocyanate with a polyhydric alcohol) and the like. In particular, from the viewpoint of reactivity and adhesion to a substrate, an adduct of an aromatic diisocyanate with a polyhydric alcohol is preferable, and an adduct of trilene diisocyanate with a polyhydric alcohol is more preferable. Polyhydric alcohols as mentioned herein include, for example, aliphatic polyhydric alcohols such as ethylene glycol, glycerin, trimethylol propane, pentaerythritol, ditrimethylol propane, and dipentaerythritol and the like, with preference given to trimethylol propane.

These aromatic isocyanates are of low compatibility with polyolefins, being compatible with the polyolefins only to the extent that does not affect the detachability of the polyolefins. Therefore, the aromatic isocyanates remaining incompatible with the polyolefins are localized between the layer with polyolefin as the major ingredient and the substrate, which are largely contributory to the adhesion between the release agent layer and the substrate.

One or more kinds of aromatic isocyanates can be used; the content thereof is 0.5 to 20 parts by weight, preferably 1.0 to 15 parts by weight, more preferably 1.5 to 10 parts by weight, relative to 100 parts by weight of polyolefins. If the content of the aromatic isocyanates is less than 0.5 parts by weight relative to 100 parts by weight of polyolefins, it is unlikely to obtain a sufficient effect on adhesion to the substrate; if the content exceeds 20 parts by weight, the effect on adhesion to a substrate no longer increases and, on the contrary, adverse influences such as shortening of the pot life arise, so that this is undesirable.

### [Polyolefin Polyol]

While the polyolefin polyol in the present invention is to be reacted with an aromatic isocyanate, it is also important that the polyol be well compatible with the polyolefin. If a polyol poorly compatible with the polyolefin is used, not only it is impossible to improve the strength and heat resistance of the release agent layer, but also the applied release agent layer becomes whitishly turbid to worsen the appearance of the coated surface.

Therefore, a polyolefin polyol whose number-average molecular weight (Mn) is 1500 to 5000, more preferably 1500 to 4000, most preferably 1500 to 3000, is suitable. If the number-average molecular weight of the polyolefin polyol exceeds 5000, the polyolefin polyol little dissolves in the layer with an aromatic isocyanate as a main component (i.e., the layer with less polyolefin) in the release agent layer because the solubility in the aromatic isocyanate is low, whereas the polyolefin polyol mostly dissolves in the layer with the polyolefin as a main component and becomes unlikely to react with the aromatic isocyanate, which in turn makes it difficult to obtain sufficient adhesion to a substrate. Also, because the content of polyolefin polyol in the layer with the polyolefin as a main component increases, the hydroxyl groups in the layer with the polyolefin as a main component occur in excess, which is likely to cause heavy peeling. Conversely, if the number-average molecular weight of polyolefin polyol is less than 1500, the amount of polyolefin polyol dissolved in the layer with an aromatic isocyanate as a main component (i.e., the layer with less polyolefin) in the release agent layer becomes so large that the content of polyolefin polyol in the layer with the polyolefin as a main component becomes too small, which in turn makes it difficult to obtain an improving effect for the strength and heat resistance of the entire release agent layer.

The kind of polyolefin polyol is not particularly limited. Examples thereof include polyethylene-based polyol, polypropylene-based polyol, polybutadiene polyol, hydrogenated polybutadiene polyol, polyisoprene polyol, hydrogenated polyisoprene polyol and the like. Of these, hydrogenated polyisoprene polyol and polyisoprene polyol are preferable, in view of the compatibility with polyolefin and influence on the peel force.

In addition, polyolefin polyol preferably has a hydroxyl value (mg KOH/g) of not less than 20, in view of the strength and curability of the coated film containing a release agent. Moreover, in view of the influence on the peel force, the hydroxyl value (mg KOH/g) is preferably not more than 75, more preferably 25-60.

In the present invention, the polyolefin polyol can be a commercially available product and, for example, Poly bdR-45HT (hydroxyl-terminated liquid polybutadiene: Mn=2800, hydroxyl value=46.6 mg KOH/g, manufactured by Idemitsu Kosan Co., Ltd.), Poly ip (hydroxyl-terminated liquid polyisoprene: Mn=2500, hydroxyl value=46.6 mg KOH/g, manufactured by Idemitsu Kosan Co., Ltd.), Epole (hydroxyl-terminated liquid hydrogenated polyisoprene: Mn=2500, hydroxyl value=50.5 mg KOH/g, manufactured by Idemitsu Kosan Co., Ltd.), GI-1000 (hydroxyl group-containing liquid hydrogenated polybutadiene: Mn=1500, hydroxyl value=60-75 mg KOH/g, manufactured by Nippon Soda Co., Ltd.), GI-2000 (hydroxyl group-containing liquid hydrogenated polybutadiene: Mn=2100, hydroxyl value=40-55 mg KOH/g, manufactured by Nippon Soda Co., Ltd.), GI-3000 (hydroxyl group-containing liquid hydrogenated polybutadiene: Mn=3000, hydroxyl value=25-35 mg KOH/g, manufactured by Nippon Soda Co., Ltd.) and the like can be preferably used. All of these polyols are liquid at 30° C.

In the present invention, one or more kinds of polyolefin polyols can be used. The content of polyolefin polyol in the release agent is set such that the value of A in the following formula is 30-250, preferably 40-200, more preferably 50-150. When the value A is smaller than 30, the strength of the release agent layer tends to be insufficient, and when it is higher than 250, heavy peeling of the layer tends to occur.

A=hydroxyl value (mg KOH/g) of polyolefin polyol x parts by weight of polyolefin polyol relative to 100 parts by weight of polyolefin

### [Urethane Catalyst]

In the present invention, a urethane catalyst may be used for the reaction of an aromatic isocyanate and a polyolefin polyol; useful urethane catalysts include catalysts for ordinary urethanization reactions. Urethane catalysts are exemplified by tin compounds such as dibutyltin dilaurate and dioctyltin dilaurate; carboxylates of metals such as zinc, cobalt, copper, and bismuth; amine compounds such as 1,4-diazabicyclo[2.2.2]octane; and chelate compounds of metals such as titanium and zirconium. Salts of bismuth with organic acid (salts of bismuth with alicyclic organic acids such as salts of bismuth with resin acids containing abietic acid, neoabietic acid, d-pimaric acid, iso-d-pimaric acid, or podocarpic acid, or a combination of two kinds or more thereof, as a main component; salts of bismuth with aromatic organic acids such as benzoic acid, cinnamic acid, and p-oxycinnamic acid; and the like) can also be used. In particular, from the viewpoint of compatibility with the release agent composition and urethanization reaction reactivity, dibutyltin dilaurate, dioctyltin dilaurate, and salts of bismuth with resin acids are preferable.

One or more kinds of urethane catalysts can be used, the content thereof being preferably 0.05 to 2.0 parts by weight, more preferably 0.1 to 1.5 parts by weight, still more preferably 0.1 to 1.0 parts by weight, relative to 100 parts by weight of polyolefin. When the content is less than 0.05 parts by weight, the catalytic effect is often insufficient; when the content exceeds 2.0 parts by weight, the catalyst is more likely to cause heavy peeling and troubles such as shortening of the pot life of the release agent in solution.

As mentioned here, the content of catalyst is expressed as parts by weight of active ingredient; for example, in the case of the solution type, prepared by dissolving an active ingredient compound like “PUCAT B7”, which is used in Examples below, in a solvent, the content means parts by weight of the active ingredient compound alone.

Where necessary, the release agent of the present invention may appropriately contain olefin-based resin other than the aforementioned polyolefin, antioxidant, UV absorber, light stabilizer such as hindered amine light stabilizer and the like, antistatic agent, fillers such as carbon black, calcium oxide, magnesium oxide, silica, zinc oxide, titanium oxide etc., pigments, and the like.

### 2. Release Material

The present invention also provides a release material having a release agent layer comprised of the aforementioned release agent on at least one surface of a substrate.

### [Substrate]

Although the substrate in the present invention is not particularly limited, a plastic film is preferable because it has a smooth surface. Examples include polyester films such as polyethylene terephthalate film and polybutylene terephthalate film and polyolefin films such as polyethylene film and polypropylene film. When paper such as craft paper, glassine paper, or fine paper is used as the substrate, preference is given to one laminated with a plastic material such as polyethylene or sealed up in order to prevent any ingredient of the release agent from impregnating the substrate in excess.

The substrate may be subjected to a corona treatment, plasma treatment, flame treatment and the like in advance as necessary. The thickness of the substrate is not limited, and can be appropriately determined depending on the object of use. In the case of a plastic film, it is generally about 12-250 μm, preferably 16-200 μm, more preferably 25-125 μm.

In addition, the substrate may appropriately contain where necessary, antioxidant, UV absorber, light stabilizer such as hindered amine light stabilizer and the like, antistatic agent, fillers such as carbon black, calcium oxide, magnesium oxide, silica, zinc oxide, titanium oxide etc., pigments, and the like.

### [Release Agent Layer]

The release agent layer in the present invention is obtained by, for example, dissolving a composition that constitutes a release agent in a diluting solvent, applying the solution to a substrate, and then drying the solution. Although the solution concentration is not particularly limited, it is adjusted normally in the range of 0.1 to 5% by weight.

The diluting solvent is not particularly limited, as far as it is capable of homogeneously dissolving the release agent composition; however, because the release agent in the present invention has a polyolefin as the primary ingredient, it is preferable from the viewpoint of homogenous dissolution to mainly use a hydrocarbon-based solvent. Hydrocarbon-based solvents are exemplified by aliphatic hydrocarbon-based solvents such as normal hexane and normal heptane, alicyclic hydrocarbon-based solvents such as cyclohexane, and aromatic hydrocarbon-based solvents such as toluene and xylene. Furthermore, as required, ketones such as methyl ethyl ketone, cyclohexanone, and acetylacetone, esters such as ethyl acetate, alcohols such as methanol, ethanol, and isopropyl alcohol and the like may be used in combination.

For a method of applying the release agent to the substrate, conventionally-used methods such as kiss-roll coater, bead coater, rod coater, Mayer bar coater, die coater, gravure coater and the like can be utilized. While the drying method is not particularly limited, a most general method is hot air drying and, depending on the heat resistance of the substrate, a release agent layer can be obtained by drying at about 80-150° C.

The thickness of the release agent layer is preferably 30 to 500 nm, more preferably 45 to 400 nm, most preferably 60 to 300 nm. When the thickness of the release agent layer is less than 30 nm, heavy peeling may sometimes arise; when the thickness exceeds 500 nm, the layer may sometimes undergo blocking when wound in the form of a roll, or the peel force may sometimes increase.

3. Adhesive Tape with Release Material

The present invention provides an adhesive tape having the above-described release material on at least one surface of an adhesive layer.

While an adhesive to be used for an adhesive layer of the adhesive tape is not particularly limited, rubber-based adhesives, acrylic adhesives, polyester-based adhesive and the like can be used. Of these, acrylic adhesives and polyester-based adhesives are preferable since they afford stable detachability.

An acrylic adhesive can be prepared by using an acrylic polymer obtained by a commonly used method of polymerization such as solution polymerization, emulsion polymerization, or UV polymerization as the principal agent, with various additives such as crosslinking agents, tackifiers, softening agents, antiaging agents, and fillers added thereto as required.

As the aforementioned acrylic polymer, a copolymer of a monomer mixture containing alkyl(meth)acrylate such as butyl(meth)acrylate, 2-ethylhexyl(meth)acrylate and the like as a main component, and, where necessary, other monomer as a copolymerizable modifying monomer (e.g., hydroxyl group-containing monomer such as 2-hydroxyethyl(meth)acrylate and the like, carboxyl group-containing monomer such as (meth)acrylic acid and the like, styrene-based monomer such as styrene and the like, vinyl esters such as vinyl acetate etc., and the like) can be used.

Examples of the polyester-based adhesive include an adhesive containing, as a base resin, a polyester-based polymer containing aliphatic carbonate diol (e.g., carbonate diol obtained by the reaction of a diol component such as butanediol and the like with a carbonate compound such as ethylenecarbonate and the like, and the like) as an inherent polyol component.

An adhesive layer can be formed by, for example, applying an adhesive solution on a release agent layer and drying the solution. The thickness of the adhesive layer can be appropriately determined in consideration of the adhesiveness and the like, and is generally 3-100 μm, preferably 5-90 μm, more preferably 10-80 μm.

### 4. Adhesive Tape Having a Back Coating Layer

The present invention also provides an adhesive tape having a back coating layer comprised of the release agent of the present invention on the outermost surface of the surface opposite to the adhesive layer via a substrate.

The adhesive tapes of the present invention may assume any of a form wound like a roll and a form of stacked sheets; in both forms, the adhesive layer can be protected by a back coating layer.

While the adhesive to be used for the adhesive tape of the present invention is not particularly limited, rubber-based adhesives, acrylic adhesives, polyester-based adhesives and the like can be used. Of these, acrylic adhesives and polyester-based adhesives are preferable, since stable detachability can be obtained.

A back coating layer can be formed by a method similar to that used for the aforementioned release agent layer, and the thickness of the back coating layer is preferably 30-500 nm, more preferably 45-400 nm, most preferably 60-300 nm, from the aspect of peel force.

In the present specification, the physical property, characteristics and the like are measured by the following methods.
(1) density

A value measured according to ASTM D1505
(2) melt flow rate (230° C.)

A value measured according to ASTM D1238
(3) number-average molecular weight

A value measured according to ASTM D2503
(4) hydroxyl value

A value measured according to JIS K1557

### EXAMPLES

The present invention is explained in more detail by referring to Examples, which are not to be construed as limitative.

The materials used in the following Examples and Comparative Examples are collectively described below.

### Polyolefin

TAFMER A-1070S (ethylene-1-butene copolymer (ethylene 85 mol %, 1-butene 15 mol %), manufactured by Mitsui Chemicals, Inc., MFR (230° C.) 2.2 g/10 min, density 0.87 g/cm³),

TAFMER A-35070S (ethylene-1-butene copolymer (ethylene 85 mol %, 1-butene 15 mol %), manufactured by Mitsui Chemicals, Inc., MFR (230° C.) 65 g/10 min, density 0.87 g/cm³)

TAFMER P-0280 (ethylene-propylene copolymer (ethylene 87 mol %, propylene 13 mol %), manufactured by Mitsui Chemicals, Inc., MFR (230° C.) 5.4 g/10 min, density 0.87 g/cm³)

TAFMER XM-7070 (propylene-based copolymer (propylene 74 mol %, 1-butene 26 mol %), manufactured by Mitsui Chemicals, Inc., MFR (230° C.) 7 g/10 min)

### Polyolefin Polyol

Epole (hydroxyl-terminated liquid hydrogenated polyisoprene, Mn=2500, hydroxyl value 50.5 mg KOH/g, manufactured by Idemitsu Kosan Co., Ltd.)

Poly ip (hydroxyl-terminated liquid polyisoprene, Mn=2500, hydroxyl value 46.6 mg KOH/g, manufactured by Idemitsu Kosan Co., Ltd.)

UNISTOLEP-901 (22% toluene solution of hydroxyl group-containing polyolefin, toluene-free product has solid, solid content Mn>5000, hydroxyl value 50 mg KOH/g, manufactured by Mitsui Chemicals, Inc.)

### Isocyanate

CORONATE L (75% ethyl acetate solution of adduct of tolylene diisocyanate with trimethylolpropane, isocyanate group number in one molecule: 3, manufactured by JAPAN POLYURETHANE INDUSTRY Co., Ltd.)

CORONATE L (75% ethyl acetate solution of adduct of tolylene diisocyanate with trimethylolpropane, isocyanate group number in one molecule: 3) manufactured by Nippon Polyurethane Industry Co., Ltd.

CORONATE HL (75% ethyl acetate solution of adduct of hexamethylene diisocyanate with trimethylolpropane, isocyanate group number in one molecule: 3) manufactured by Nippon Polyurethane Industry Co., Ltd.

TSS-100: “DURANATE TSS-100” (isocyanurate adduct of hexamethylene diisocyanate, isocyanate group content: 17.6%) manufactured by Nippon Polyurethane Industry Co., Ltd.

TAKENATE D110N (75% ethyl acetate solution of adduct of xylylene diisocyanate with trimethylolpropane, isocyanate group number in one molecule: 3, manufactured by Mitsui Chemicals, Inc.)

MILLIONATE MT (diphenylmethanediisocyanate, isocyanate group number in one molecule: 2, manufactured by JAPAN POLYURETHANE INDUSTRY Co., Ltd.)

### Urethane Catalyst

dibutyltin dilaurate (manufactured by Wako Pure Chemical Industries)

EMBILIZER OL-1 (dioctyltindilaurate, manufactured by Tokyo Fine Chemical CO., LTD.)

PUCAT B7 (58% mineral spirit solution of bismuth resinate, manufactured by NIHON KAGAKU SANGYO CO., LTD.)

In addition, the release materials produced in Examples and Comparative Examples were evaluated according to the methods shown below.

### (1) Adhesion of Release Agent Layer to Substrate

The surface of the release agent layer of each release material was rubbed with fingertips in three reciprocations, and the surface was judged.
◯: Unchanged, or the surface becomes whitishly turbid but no shedding of the coating.
×: The coating is shed in pieces to generate residues as if using a rubber eraser, causing the substrate to get exposed.

### (2) Peel Force in Normal State

Acrylic adhesive tape No. 31B with 50 mm width (manufactured by Nitto Denko Corporation) was bonded to the surface of the release agent layer of each release material using a hand roller; after storage at 23° C. for 24 hours, the tape was pulled in a 180° direction at a speed of 0.3 m/min using a tensile tester, and the peel force was measured in 23° C. atmosphere.

### (3) Post-Heating Peel Force

Acrylic adhesive tape No.31B with 50 mm width (manufactured by Nitto Denko Corporation) was bonded to the surface of a release agent layer of each release material using a hand roller; after heating at 70° C. for 24 hours, the tape was cooled at 23° C. for 1 to 2 hours and pulled in a 180° direction at a speed of 0.3 m/min using a tensile tester, and the peel force was measured in 23° C. atmosphere.

(4) Peel Force Maintainability Compared with Simple-Substance Polyolefin

The peel force after heating for the release materials of Examples 1 to 7 and Comparative Examples 1 to 4 were compared with the post-heating peel forces for release materials formed with the same ingredients as the release materials but using polyolefin alone, respectively (any one of Comparative Examples 5 to 7) (specifically, Examples 1 to 3 and Examples 5 to 6 were compared with Comparative Example 5, Example 4 was compared with Comparative Example 6, Example 7 was compared with Comparative Example 7, and Comparative Examples 1 to 4 were compared with Comparative Example 5); when the post-heating peel force was 1.5 times or less compared with the post-heating peel force for the release material formed with simple-substance polyolefin, the rating for peel force maintainability was ◯; when the post-heating peel force exceeded 1.5 times, the rating for peel force maintainability was ×.

### Example 1

TAFMERA-1070S/Epole/CORONATE L/dibutyltin dilaurate=100/2/10/0.2 (weight ratio of solid content) was dissolved in toluene to give a release agent solution with a concentration of 1.5%. The release agent solution was applied to a 38 μm-thick polyester film with a mayer bar #6, and heated by a hot air dryers at 130° C.×1 min to give a release material. The thickness of the release agent layer of the obtained release material was about 150 nm.

### Example 2

In the same manner as in Example 1 except that the substrate was changed to a 40 μm-thick biaxially-oriented polypropylene film with one corona-treated surface (corona-treated surface wetting index 39 mN/m), a release material was prepared. A release agent was applied to the corona-treated surface.

### Example 3

In the same manner as in Example 1 except that the substrate was changed to a 60 μm-thick polyethylene film with one corona-treated surface (corona-treated surface wetting index 50 mN/m), a release material was prepared. A release agent was applied to the corona-treated surface.

### Example 4

In the same manner as in Example 1 except that the composition of the release agent was set to TAFMERP-0280/TAFMER A-35070S/Epole/CORONATE L/dibutyltin dilaurate=60/40/1/3/0.2 (weight ratio of solid content), a release material was prepared.

### Example 5

In the same manner as in Example 1 except that the composition of the release agent was set to TAFMER A-1070S/Epole/TAKENATE D110N/dibutyltin dilaurate=100/2/5/0.2 (weight ratio of solid content), a release material was prepared.

### Example 6

In the same manner as in Example 1 except that the composition of the release agent was set to TAFMER A-1070S/Epole/CORONATE L/PUCATB7=100/2/3/0.6 (weight ratio of solid content), a release material was prepared.

### Example 7

In the same manner as in Example 1 except that the composition of the release agent was set to TAFMER XM-7070/Poly ip/CORONATE L/EMBILIZER OL-1=100/2/0.5/1 (weight ratio of solid content), a release material was prepared.

### Comparative Example 1

In the same manner as in Example 1 except that the composition of the release agent was set to TAFMERA-1070S/Epole/CORONATEHL/dibutyltin dilaurate=100/2/10/0.2 (weight ratio of solid content), a release material was prepared.

### Comparative Example 2

In the same manner as in Example 1 except that the composition of the release agent was set to TAFMER A-1070S/Epole/CORONATE HX/dibutyltin dilaurate=100/2/1.6/0.2 (weight ratio of solid content), a release material was prepared.

### Comparative Example 3

In the same manner as in Example 1 except that the composition of the release agent was set to TAFMER A-1070S/Epole/MILLIONATE MT/dibutyltin dilaurate=100/2/5/0.2 (weight ratio of solid content), a release material was prepared.

### Comparative Example 4

In the same manner as in Example 1 except that the composition of the release agent was set to TAFMER A-1070S/UNISTOLE P-901/CORONATE L/dibutyltin dilaurate=100/2/3/0.2 (weight ratio of solid content), a release material was prepared.

### Comparative Example 5

In the same manner as in Example 1 except that the composition of the release agent was set to TAFMER A-1070S=100, a release material was prepared.

### Comparative Example 6

In the same manner as in Example 1 except that the composition of the release agent was set to TAFMER P-0280/TAFMER A-35070S=60/40 (weight ratio of solid content), a release material was prepared.

### Comparative Example 7

In the same manner as in Example 1 except that the composition of the release agent was set to TAFMER XM-7070=100, a release material was prepared.

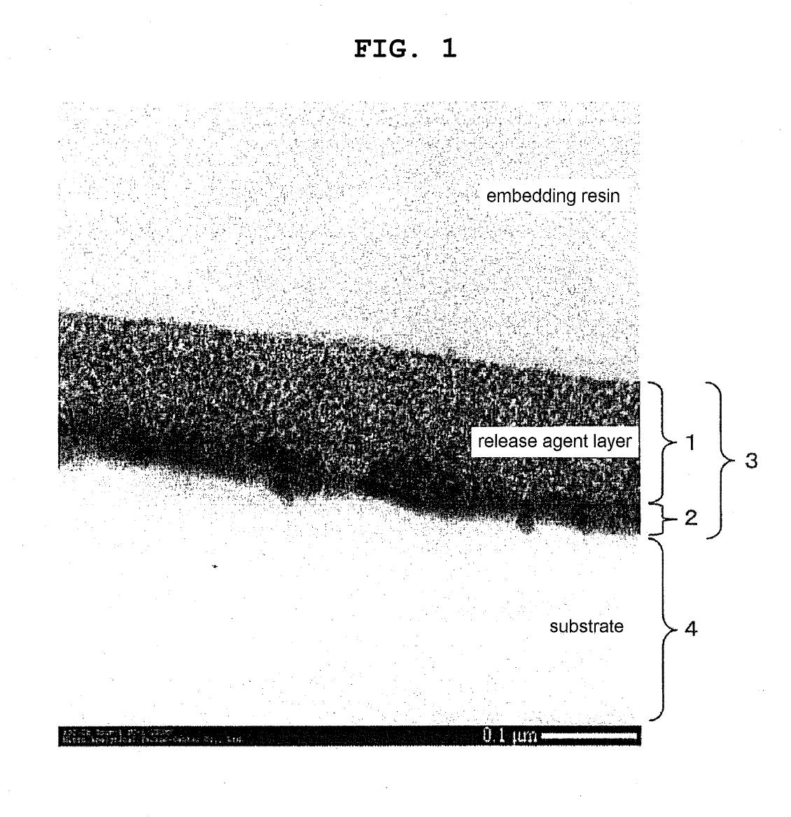

FIG. 1 is a transmission electron microscopy (TEM) photomicrograph of a cross-section of the release agent layer in the release material prepared in Example 1, taken by subjecting the release material to a staining treatment (immersion in 2% by weight aqueous solution of ruthenic acid for about 2 hours), then embedding the material in epoxy resin, cutting the same into about 100 nm thickness by ultramicrotomy, and imaging one of the resulting samples using a transmission electron microscope (HITACHI H-7650, acceleration voltage 100 kV).

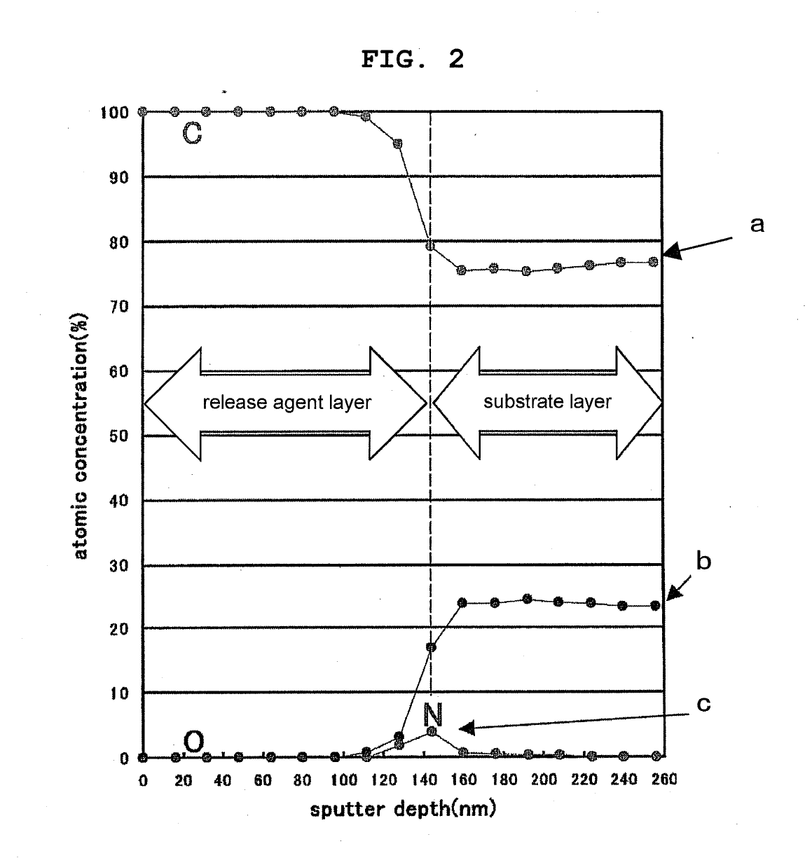

FIG. 2 is a drawing showing the results of an X-ray photoelectron spectroscopy (XPS) analysis in the depth direction of the release agent layer in the release material generated in Example 1. In the drawing, the arrow a indicates carbon coming from the release agent and the substrate, the arrow b indicates oxygen coming from the release agent and the substrate (polyester film), and the arrow c indicates nitrogen coming from the isocyanate in the release agent.

The analysis apparatus and measurement conditions are as described below.

ESCA apparatus: Quantera SXM, manufactured by ULVAC-PHI, Incorporated

X-RAY source: monochrome Al Kα

X ray Setting: 100 μmφ [25 W (15 kV) ]

photoelectron take-off angle: 45 degrees to sample surface

neutralization conditions: combined use of neutralization gun and Ar ion gun (neutralization mode)

pressurization voltage of C₆₀ ion gun: 10 kV

raster size of C₆₀ ion gun: 0.5 mm×2 mm

etching rate of C_{α}ion gun: about 16 nm/min

It is seen from FIG. 1 and FIG. 2 that the release agent of the present invention, because of the low compatibility between polyolefins and aromatic isocyanates, segregates into a layer with a polyolefin as a main component and a layer with an aromatic isocyanate as a main component, the layer with the aromatic isocyanate as a main component being localized between the layer with the polyolefin as a main component and the substrate. For this reason, it is thought that good adhesion to a substrate can be obtained without affecting the inherent detachability of the polyolefin.

The evaluation results of the release materials prepared in Examples and Comparative Examples are shown in Table 1.

TABLE 1

| | adhesion of | | | peel force |
|---|---|---|---|---|
| | release | normal | peel force | maintainability |
| | agent layer | condition | after | compared to |
| | to | peel force | heating | polyolefin |
| | substrate | [N/50 mm] | [N/50 mm] | alone |
| Example 1 | ◯ | 0.15 | 0.15 | ◯ |
| Example 2 | ◯ | 0.15 | 0.16 | ◯ |
| Example 3 | ◯ | 0.15 | 0.15 | ◯ |
| Example 4 | ◯ | 0.13 | 0.13 | ◯ |
| Example 5 | ◯ | 0.15 | 0.15 | ◯ |
| Example 6 | ◯ | 0.13 | 0.15 | ◯ |
| Example 7 | ◯ | 3.50 | 3.70 | ◯ |
| Comparative | X | 0.16 | 0.17 | ◯ |
| Example 1 | | | | |
| Comparative | X | 0.15 | 0.35 | X |
| Example 2 | | | | |
| Comparative | X | 0.18 | 0.97 | X |
| Example 3 | | | | |
| Comparative | ◯ | 0.17 | 0.65 | X |
| Example 4 | | | | |
| Comparative | X | 0.14 | 0.14 | — |
| Example 5 | | | | |
| Comparative | X | 0.13 | 0.14 | — |
| Example 6 | | | | |
| Comparative | X | 3.50 | 3.60 | — |
| Example 7 | | | | |

The release materials of Examples 1-7 were superior in the adhesion of release agent layer to the substrate. By comparison of the release materials of the Examples with the release materials (any of Comparative Examples 5-7) formed solely from the same polyolefin as that used for the release materials (Examples 1-3 and Examples 5-6 were compared with Comparative Example 5, Example 4 was compared with Comparative Example 6, and Example 7 was compared with Comparative Example 7), any release material of Examples 1-7 showed almost the same levels of normal condition peel force and peel force after heating as those of the release materials formed solely from polyolefin, and maintained the inherent detachability of polyolefin.

In contrast, the release materials of Comparative Example 1 and Comparative Example 2 using aliphatic isocyanate showed insufficient adhesion to the substrate. In addition, the release material of Comparative Example 2 showed an increased peel force after heating, and could not maintain the inherent detachability of polyolefin.

The release material of Comparative Example 3 using aromatic isocyanate containing less than 3 isocyanate groups in one molecule showed insufficient adhesion to the substrate. In addition, it showed an increased peel force after heating, and could not maintain the inherent detachability of polyolefin.

The release material of Comparative Example 4 using aromatic isocyanate containing not less than 3 isocyanate groups in one molecule showed adhesion to the substrate. However, the use of polyolefin polyol having a number-average molecular weight (Mn) of more than 5000 caused a large amount of polyol remaining in the layer containing polyolefin as a main constituent. As a result, the peel force after heating increased due to the hydroxyl group of the polyol, and the inherent detachability of polyolefin could not be maintained.

Thus, a release material simultaneously affording adhesion to the substrate and maintainability of the inherent detachability of polyolefin could not be obtained from Comparative Examples.

This application is based on patent application Nos. 2009-184531 and 2010-162230 filed in Japan, the contents of which are incorporated in full herein.

### EXPLANATION OF SYMBOLS

1 layer containing polyolefin as a main constituent

2 layer containing isocyanate as a main constituent

3 release agent layer

4 substrate

1. A release agent comprising at least a polyolefin, an aromatic isocyanate having three or more isocyanate groups in one molecule, and a polyolefin polyol having a number-average molecular weight of 1500 to 5000.

2. The release agent according to claim 1, wherein the aromatic isocyanate is an adduct of an aromatic diisocyanate with a polyhydric alcohol.

3. The release agent according to claim 1, wherein the content of the aromatic isocyanate is 0.5 to 20 parts by weight relative to 100 parts by weight of the polyolefin.

4. A release material having a release agent layer comprising the release agent according to any one of claims 1 to 3 claim 1 on at least one surface of a substrate.

5. An adhesive tape having the release material according to claim 4 on at least one surface of an adhesive layer.

6. An adhesive tape having an adhesive layer on one surface of a substrate, and having a back coating layer comprising the release agent according to claim 1 on the outermost surface of the other surface.

7. The release agent according to claim 2, wherein the content of the aromatic isocyanate is 0.5 to 20 parts by weight relative to 100 parts by weight of the polyolefin.

8. A release material having a release agent layer comprising the release agent according to claim 2 on at least one surface of a substrate.

9. A release material having a release agent layer comprising the release agent according to claim 3 on at least one surface of a substrate.

10. A release material having a release agent layer comprising the release agent according to claim 7 on at least one surface of a substrate.

11. An adhesive tape having the release material according to claim 8 on at least one surface of an adhesive layer.

12. An adhesive tape having the release material according to claim 9 on at least one surface of an adhesive layer.

13. An adhesive tape having the release material according to claim 10 on at least one surface of an adhesive layer.

14. An adhesive tape having an adhesive layer on one surface of a substrate, and having a back coating layer comprising the release agent according to claim 2 on the outermost surface of the other surface.

15. An adhesive tape having an adhesive layer on one surface of a substrate, and having a back coating layer comprising the release agent according to claim 3 on the outermost surface of the other surface.
